(19) United States
(12) Patent Application Publication
(10) Pub. No.: US 2010/0225754 A1
(43) Pub. Date: Sep. 9, 2010

(54) MEDICAL INSTRUMENT

(75) Inventors: Nobuyoshi Yazawa, Tokyo (JP); Hitoshi Karasawa, Tokyo (JP); Daisuke Asada, Tokyo (JP); Sho Nakajima, Tokyo (JP); Tsutomu Urakawa, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS MEDICAL SYSTEMS CORP., Tokyo (JP)

(21) Appl. No.: 12/719,299

(22) Filed: Mar. 8, 2010

Related U.S. Application Data
(63) Continuation of application No. PCT/JP2009/066295, filed on Sep. 17, 2009.

(30) Foreign Application Priority Data
Oct. 10, 2008 (JP) 2008-264502

(51) Int. Cl. H04N 7/18

(52) U.S. Cl. 348/68; 348/E07.085

(57) ABSTRACT

A medical instrument according to the present invention is a medical instrument used by being introduced into the body and fixed therein, which includes a fixing section fixed to a body wall in the body, an image pickup section that picks up an image of an object to be examined in the body, an illumination section that illuminates the object to be examined in the body and a sheet body in which the illumination section is disposed and which is made unfoldable so as to spread with respect to the image pickup section so that an illumination region of illumination light is expanded in an image pickup region of the image pickup section and a wide range is irradiated with the illumination light, and can thereby irradiate the object to be examined whose images are taken with illumination light of sufficient brightness and luminous intensity distribution.

### CROSS REFERENCE TO RELATED APPLICATION

This application is a continuation application of PCT/JP2009/066295 filed on Sep. 17, 2009 and claim benefit of Japanese Application No. 2008-264502 filed in Japan on Oct. 10, 2008, the entire contents of which are incorporated herein by this reference.

### BACKGROUND OF THE INVENTION

1. Field of the INVENTION

The present invention relates to a medical instrument provided with image pickup means which is left indwelling and fixed to the inside of the abdominal wall of a patient.

2. Description of the Related Art

As is well known, endoscope apparatuses, which are medical instruments, are provided with an image pickup apparatus, which is image pickup means, designed to be introduced into a body cavity of a patient and perform various types of inspections and treatments of affected areas in the body based on observed images taken by the image pickup apparatus. Examples of such endoscopes include those introduced into digestive organs such as esophagus, stomach, large intestine and duodenum, which are tube cavities and tubes in the body from the oral cavity or anus and those introduced into the abdominal cavity from the vicinity of the umbilical region by puncturing through the body wall.

In order to obtain a sufficient illumination light quantity to take images using the image pickup apparatus of such an endoscope, for example, Japanese Patent Application Laid-Open Publication No. 2001-37717 discloses an endoscope apparatus including a cover with a light exit window for illumination light provided in an insertion portion, wherein the cover is rotated to cause the light exit window to face an object and to thereby increase the illumination light quantity. When inserted into or removed from the body, this conventional endoscope apparatus closes the cover so as to prevent the outside diameter of the insertion portion from increasing.

On the other hands, in addition to inspection inside the digestive tract, surgical operations that conduct therapy or treatment while observing organs in the body, so-called “laparoscopic surgical operations” are becoming a focus of attention in recent years. This laparoscopic surgical operation is a minimally-invasive operation which, rather than creating a large opening in the abdomen performs treatment by puncturing, through the abdomen of the patient, a trocar that guides an observation endoscope into the body cavity and a trocar that guides a treatment instrument to a treatment region and introducing the endoscope into the abdominal cavity.

### SUMMARY OF THE INVENTION

A medical instrument of the present invention is a medical instrument used by being introduced into a body and fixed thereto, including a fixing section fixed to a body wall in the body, an image pickup section that picks up an image of an object to be examined in the body, an illumination section that illuminates the object to be examined in the body, and a sheet body in which the illumination section is disposed and which is made unfoldable so as to form a plane that spreads over a wide angle from a direction orthogonal to a central axis of the illumination section in an illumination direction so that an irradiation region of illumination light is expanded in an image pickup region of the image pickup section and a wide range is irradiated with the illumination light.

### BRIEF DESCRIPTION OF THE DRAWINGS

FIG. 1 is a cross-sectional view illustrating a configuration of a camera set up in the abdominal cavity according to a first embodiment of the present invention;

FIG. 2 is a diagram illustrating a sheet body of the camera set up in the abdominal cavity according to the first embodiment of the present invention, which is unfolded;

FIG. 3 is a cross-sectional view illustrating the camera set up in the abdominal cavity according to the first embodiment of the present invention, which is set up in the abdominal cavity;

FIG. 4 is a plan view illustrating a configuration of a camera set up in the abdominal cavity according to a second embodiment of the present invention;

FIG. 5 is a side view illustrating the configuration of the camera set up in the abdominal cavity according to the second embodiment of the present invention;

FIG. 6 is a perspective view illustrating the sheet body of the camera set up in the abdominal cavity according to the second embodiment of the present invention, which is deformed into a cylindrical shape;

FIG. 7 is a graph illustrating conditions of a modulus of elasticity and temperature of the sheet body of the camera set up in the abdominal cavity according to the second embodiment of the present invention;

FIG. 8 is a perspective view illustrating the camera set up in the abdominal cavity according to the second embodiment of the present invention introduced into the body via a trocar;

FIG. 9 is a diagram illustrating the sheet body of the camera set up in the abdominal cavity according to the second embodiment of the present invention warmed up with illumination light of the endoscope so as to unfold;

FIG. 10 is a diagram illustrating how the unfolded camera set up in the abdominal cavity according to the second embodiment of the present invention is pasted to the abdominal wall;

FIG. 11 is a plan view illustrating a configuration of a camera set up in the abdominal cavity according to a first modification example of the second embodiment of the present invention;

FIG. 12 is a plan view illustrating a configuration of a camera set up in the abdominal cavity according to a second modification example of the second embodiment of the present invention;

FIG. 13 is a plan view illustrating a configuration of a camera set up in the abdominal cavity according to a third embodiment of the present invention;

FIG. 14 is a diagram illustrating how the camera set up in the abdominal cavity according to the third embodiment of the present invention is folded;

FIG. 15 is a diagram illustrating the camera set up in the abdominal cavity according to the third embodiment of the present invention, which is inserted in the trocar grasped by the treatment instrument;

FIG. 16 is a cross-sectional view illustrating the camera set up in the abdominal cavity according to the third embodiment of the present invention, which is left indwelling and fixed to the abdominal wall in the abdominal cavity;

FIG. 17 is a plan view illustrating a configuration of a camera set up in the abdominal cavity according to a fourth embodiment of the present invention in which a sheet body provided with an illumination section is folded;

FIG. 18 is a plan view illustrating the configuration of the camera set up in the abdominal cavity according to the fourth embodiment of the present invention in which the sheet body provided with the illumination section is unfolded;

FIG. 19 is a cross-sectional view illustrating the configuration of the camera set up in the abdominal cavity according to the fourth embodiment of the present invention;

FIG. 20 is a perspective view of the camera set up in the abdominal cavity according to the fourth embodiment of the present invention to illustrate how the sheet body provided with the illumination section unfolds;

FIG. 21 is a plan view illustrating a configuration of a camera set up in the abdominal cavity according to a fifth embodiment of the present invention;

FIG. 22 is a side view illustrating the configuration of the camera set up in the abdominal cavity according to the fifth embodiment of the present invention in FIG. 21;

FIG. 23 is a side view illustrating a configuration of a camera set up in the abdominal cavity according to a sixth embodiment of the present invention;

FIG. 24 is a plan view illustrating the configuration of the camera set up in the abdominal cavity according to the sixth embodiment of the present invention in FIG. 23;

FIG. 25 is a perspective view illustrating a configuration of a camera set up in the abdominal cavity according to a modification example of the sixth embodiment of the present invention;

FIG. 26 is a cross-sectional view illustrating a configuration of a camera set up in the abdominal cavity according to a seventh embodiment of the present invention; and

FIG. 27 is a plan view illustrating the camera set up in the abdominal cavity according to the seventh embodiment of the present invention in FIG. 26, in which the sheet body is unfolded.

### DETAILED DESCRIPTION OF THE REFERRED EMBODIMENTS

Hereinafter, embodiments of the present invention will be described with reference to the accompanying drawings. In the following descriptions, for example, a medical apparatus provided with a medical instrument for conducting an abdominal cavity laparoscopic surgical operation will be illustrated.

### First Embodiment

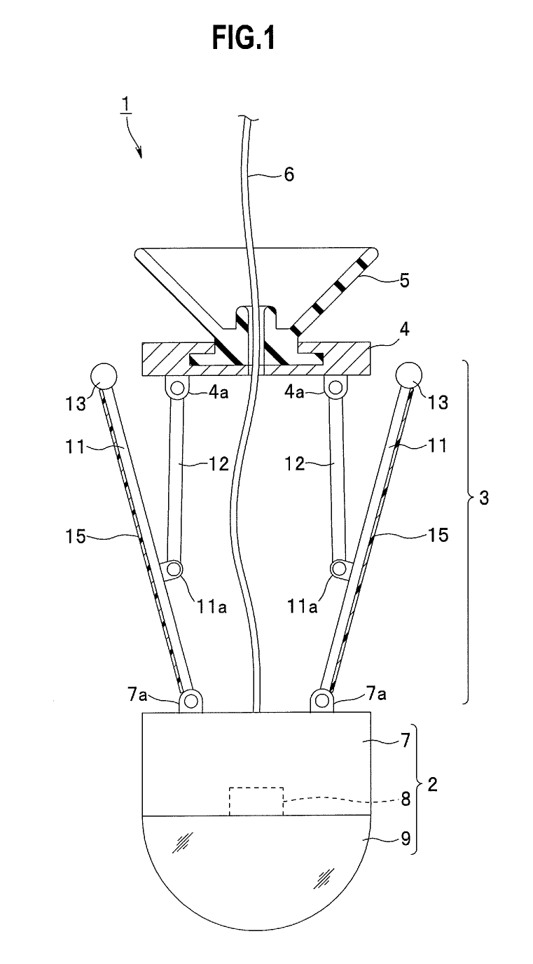

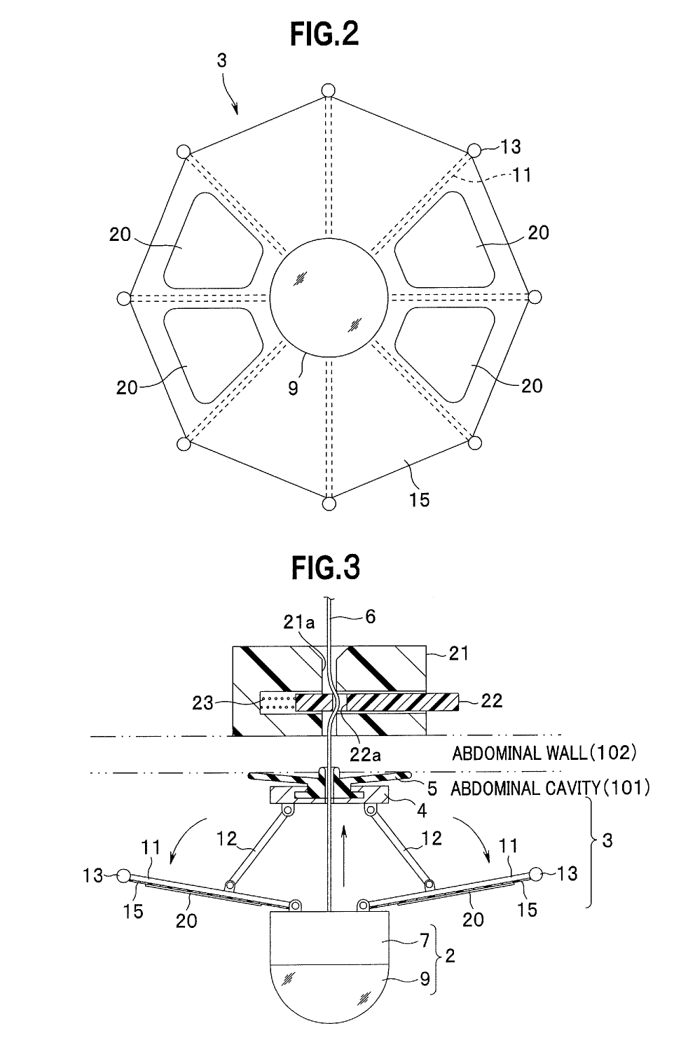

First, a camera set up in the abdominal cavity, which is a medical instrument according to the present invention used for an abdominal cavity laparoscopic surgical operation, will be described below. FIG. 1 to FIG. 3 are related to a first embodiment of the present invention, FIG. 1 is a cross-sectional view illustrating a configuration of a camera set up in the abdominal cavity, FIG. 2 is a diagram illustrating a sheet body of the camera set up in the abdominal cavity, which is unfolded and FIG. 3 is a cross-sectional view illustrating the camera set up in the abdominal cavity, which is set up in the abdominal cavity.

As shown in FIG. 1 to FIG. 3, the camera set up in the abdominal cavity (hereinafter simply referred to as “camera”) 1 of the present embodiment is configured by including a camera unit 2 which is image pickup means, an opening/closing section 3 provided with a plane light source or the like, an abdominal wall fixing section 4 into which a suction cup 5 making up means for fixing to an inner wall of the body is fitted and a cable 6, which is connected to the camera unit 2 at one end and penetrates the abdominal wall fixing section 4 and the suction cup 5.

The camera unit 2 is configured by including a camera body 7 incorporating a solid image pickup device such as CCD or CMOS and an image pickup unit 8 provided with an objective lens group that condenses image taking light to the solid image pickup device and a dome-like transparent cover body 9 disposed on one surface which is a front surface of the camera body 7.

The above described cable 6 extends from the center of the other surface which is a rear surface of the camera body 7. This cable 6 is a composite cable for supplying power to the image pickup unit 8 of the camera unit 2 and illumination sections 20 (see FIG. 2) which are illumination means and will be described later, and transmitting a video signal photoelectrically converted by the image pickup unit 8 to a camera control unit (CCU), which is an external device (not shown). The image taken by the image pickup unit 8 is subjected to image processing by the CCU and displayed on an outside monitor (not shown).

The opening/closing section 3 is configured by including a plurality of (here eight) ribs 11, a plurality of (here eight) stretchers 12, one ends of which are pivotably attached to the ribs 11, and a sheet body 15, which is a thin-film to which the ribs 11 are radially pasted in uniform spacing.

The plurality of ribs 11 are each provided, at some midpoint thereof, with a pivot support section 11a at which one end of the stretcher 12 is pivotably connected. One ends of the ribs 11 are individually pivotably connected to a plurality of pivot support sections 7a disposed on the back surface of the camera body 7 of the camera unit 2 and protective bodies 13 formed of a quasi-spherical elastic member are provided at the other ends of the ribs 11. This protective body 13 is intended to prevent edges of the ribs 11 introduced into the body from damaging body tissue.

The stretchers 12 pivotably connected to the pivot support sections 11a of the ribs 11 at one ends are individually pivotably connected, at the other ends thereof, to a plurality of pivot support sections 4a provided on the other surface opposite to the surface on which the suction cup 5 of the abdominal wall fixing section 4 is disposed.

In the above described configuration, the plurality of ribs 11 or the plurality of stretchers 12 pivot about the respective pivot support sections 4a, 7a and 11a through a pulling/slackening operation of the cable 6, which is operation means, and the opening/closing section 3 is thereby configured to be made changeable between an open state in which the plurality of ribs 11 are radially expanded and a closed state in which the plurality of ribs 11 are placed close to each other.

Accordingly, the sheet body 15 pasted to the plurality of ribs 11 is made changeable between the open state as shown in FIG. 2 in which the ribs 11 have radially spread and unfolded and a closed state in which the plurality of ribs 11 have come closer to each other and folded. That is, the sheet body 15 is unfolded and spread in a so-called skeletal structure of an umbrella.

A plurality of (here, four) illumination sections 20, which are plane light sources, are disposed on surfaces of the sheet body 15 between the neighboring ribs 11. For example, plane light sources of organic EL are used for these illumination sections 20 so that the illumination sections 20 are deformable even when the sheet body 15 is folded. Power to the illumination sections 20 is configured to be supplied from the cable 6 through the camera unit 2 via wiring (not shown).

The camera 1, which is a medical instrument of the present embodiment in such a configuration is used for an abdominal cavity laparoscopic surgical operation and used to take images of a treatment region when an organ or the like in the abdominal cavity 101, which is one of the body cavities of the patient is treated as shown in FIG. 3.

First, the camera 1 of the present embodiment is introduced into the abdominal cavity 101 of the patient via a trocar punctured into the abdominal wall 102. The cable 6 of the camera 1 is held by a puncture needle (not shown) or the like and pulled out of the body passing through abdominal wall 102.

Next, the cable 6 of the camera 1 is passed through a hole 21a of a fixing unit 21 provided on the abdomen side of the patient and pulled toward the abdominal wall 102 side. The cable 6 is pulled toward the outside of the body until the suction cup 5 of the camera 1 sticks fast to the inner surface of the abdominal wall 102.

When the cable 6 is further pulled toward the outside of the body in this state, the camera unit 2 is lifted so as to come closer to the abdominal wall fixing section 4, the plurality of ribs 11 or the plurality of stretchers 12 pivot about the respective pivot support sections 4a, 7a and 11a, and the plurality of ribs 11 thereby spread radially and the opening/closing section 3 is placed in an open state. As shown in FIG. 2, an open state is set in which the sheet body 15 is unfolded in the abdominal cavity 101. Thus, as the sheet body 15 unfolds, the four illumination sections 20 spread around the camera unit 2.

The fixing unit 21 is provided with a fixing lever 22 that fixes the cable 6 of the camera 1 outside the body. A hole 22a through which the cable 6 passes is formed at some midpoint of the fixing lever 22 and the fixing lever 22 is urged toward one side of the fixing unit 21 by a spring 23 provided in the fixing unit 21 so that the position of the hole 22a is deviated from the position of the hole 21a of the fixing unit 21.

That is, when the user pushes the fixing lever 22 into the fixing unit 21 up to a position at which the hole 21a of the fixing unit 21 substantially matches the hole 22a of the fixing lever 22 against the urging force of the spring 23, the user can easily pull the cable 6. When the user stops pushing the fixing lever 22 into the fixing unit 21, the fixing lever 22 then slides by receiving the urging force of the spring 23.

Therefore, since the position of the hole 22a of the fixing lever 22 deviates from the position of the hole 21a of the fixing unit 21, the cable 6 of the camera 1 that passes through the holes 21a and 22a is sandwiched and fixed in the fixing unit 21. The opening/closing section 3 of the camera 1 is thereby kept in an open state.

As described above, according to the camera 1 of the present embodiment, the four illumination sections 20 provided around the camera unit 2 spread over a wide range as the sheet body 15 of the opening/closing section 3 unfolds, and it is thereby possible to irradiate the image taking region of the image pickup unit 8 in the camera unit 2 with illumination light of sufficient brightness and luminous intensity distribution. That is, with the provision of the illumination sections 20 that unfold and spread when used and that can make variable the area of irradiation of illumination light, in other words, irradiation region to be expanded, in such a small camera 1 of the present embodiment that is introduced into the abdominal cavity, it is possible to improve the brightness of illumination light and luminous intensity distribution characteristics. Thus, the camera 1 can have a configuration capable of obtaining sufficient illumination light to illuminate the object.

The camera 1 may also be configured so as to wirelessly transmit an image signal to an external device. In this case, by providing an antenna in the sheet body 15 of the opening/closing section 3, it is also possible to improve directivity of the antenna.

### Second Embodiment

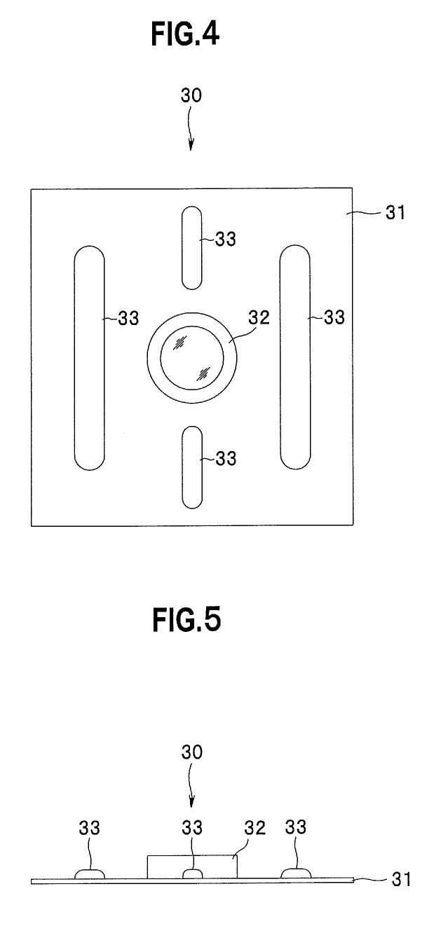

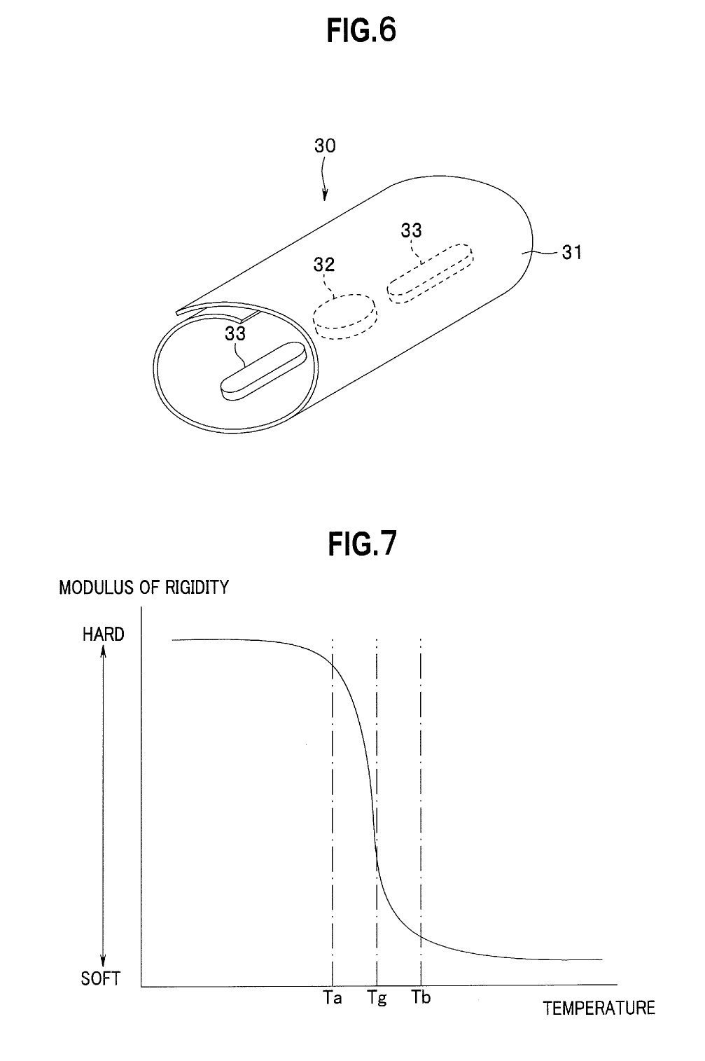

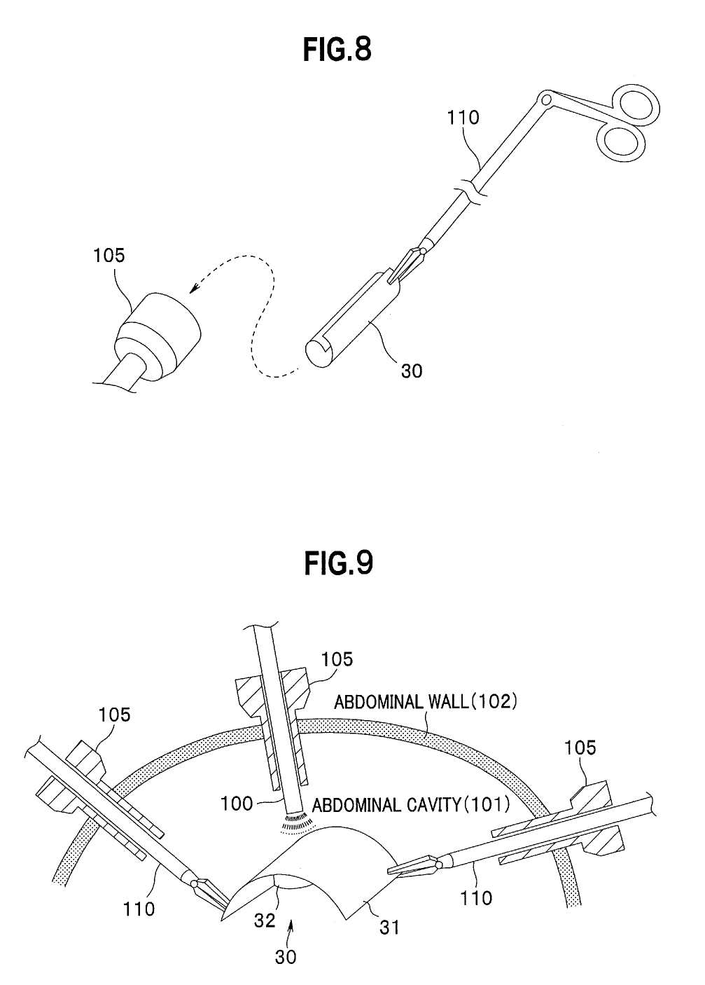

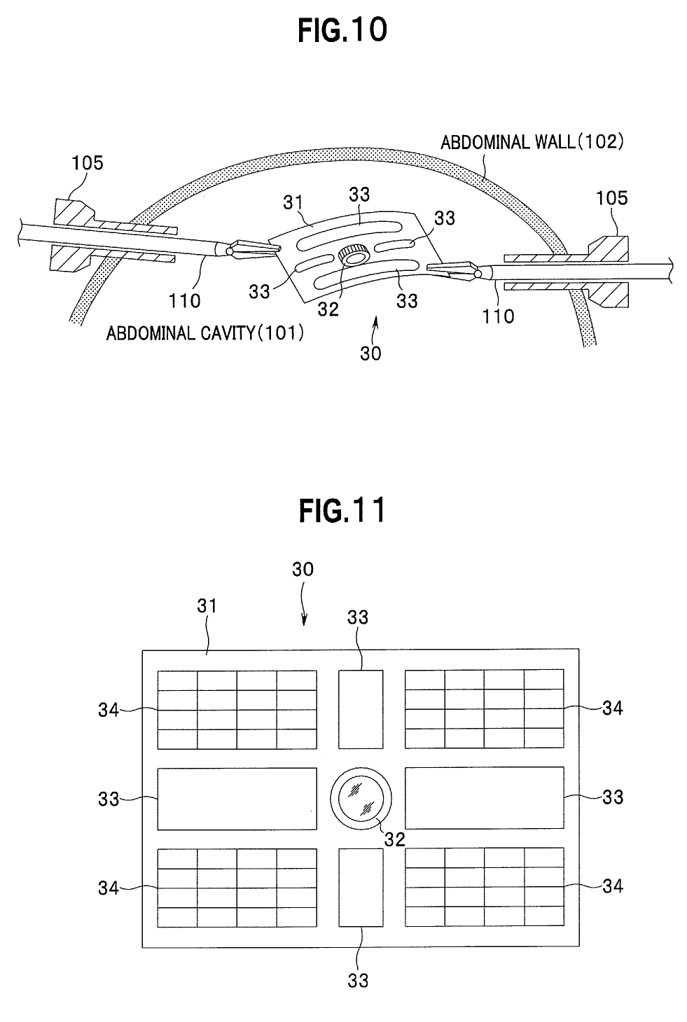

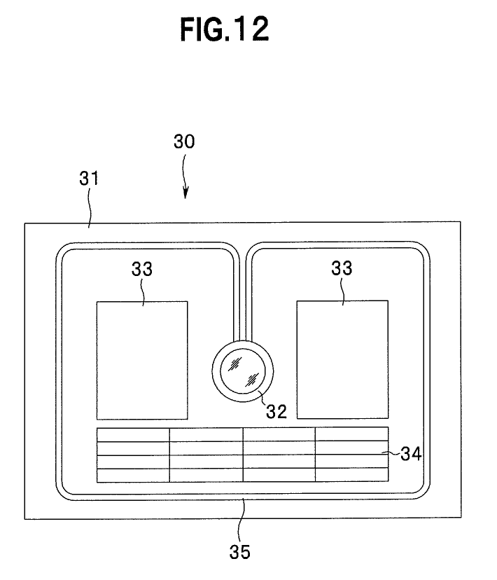

Next, a second embodiment of the camera set up in the abdominal cavity, which is a medical instrument of the present invention will be described below using FIG. 4 to FIG. 12. FIG. 4 to FIG. 12 are related to the second embodiment of the present invention. FIG. 4 is a plan view illustrating a configuration of the camera set up in the abdominal cavity, FIG. 5 is a side view illustrating the configuration of the camera set up in the abdominal cavity, FIG. 6 is a perspective view illustrating the sheet body of the camera set up in the abdominal cavity, which is deformed into a cylindrical shape, FIG. 7 is a graph illustrating conditions of a modulus of elasticity and temperature of the sheet body of the camera set up in the abdominal cavity, FIG. 8 is a perspective view illustrating how the camera set up in the abdominal cavity is introduced into the body via a trocar, FIG. 9 is a diagram illustrating how the sheet body of the camera set up in the abdominal cavity is warmed up with illumination light of the endoscope so as to unfold, FIG. 10 is a diagram illustrating how the unfolded camera set up in the abdominal cavity is pasted to the abdominal wall, FIG. 11 is a plan view illustrating a configuration of a camera set up in the abdominal cavity according to a first modification example and FIG. 12 is a plan view illustrating a configuration of a camera set up in the abdominal cavity according to a second modification example.

The camera set up in the abdominal cavity (hereinafter also simply referred to as “camera”) 30 of the present embodiment is configured by including a rectangular thin-film sheet body 31, a camera unit 32, which is image pickup means, disposed at substantially the center of one surface of the sheet body 31 and four illumination sections 33, which are illumination means, provided around the camera unit 32 of the sheet body 31 as shown in FIG. 4 and FIG. 5.

As in the case of the first embodiment, the camera unit 32 is provided with a solid image pickup device such as CCD or CMOS and an objective lens group that condenses image taking light to this solid image pickup device. Furthermore, the camera unit 32 of the present embodiment incorporates an image pickup unit including a battery. The camera 30 has a configuration in which a video signal photoelectrically converted by the image pickup unit of the camera unit 32 is wirelessly transmitted to a receiver of an external device by a transmitter provided in the camera unit 32.

The four illumination sections 33 are configured to irradiate illumination light onto an object using, for example, LED light sources or organic EL plane light sources. When LEDs are used as light sources, the illumination sections 33 of the present embodiment are arranged on the sheet body 31 in the same longitudinal direction, that is, in parallel. Furthermore, these illumination sections 33 receive a power supply from a battery in the camera unit 32.

When the camera 30 of the present embodiment is not used, the sheet body 31 is deformed into a quasi-cylindrical shape as shown in FIG. 6. Since the longitudinal directions of the aforementioned four illumination sections 33 are parallel, the sheet body 31 is rounded into a quasi-cylindrical shape so that the direction along the longitudinal direction of the illumination sections 33 corresponds to the major axis direction.

This sheet body 31 is formed, for example, of a polyurethane-based shape-memory polymer, and a water-activated adhesive making up means for fixing to the body wall is applied to the other entire surface opposite to the one surface on which the camera unit 32 and four illumination sections 33 are disposed. This water-activated adhesive is an adhesive whose adhesive force is generated when a contact is made with the wet abdominal wall 102 and which has bio compatibility such as fibrin-based adhesive/sticker, albumin-based adhesive/sticker or cyanoacrylate-based adhesive/sticker.

Furthermore, the sheet body 31 has a characteristic that its rigidity versus temperature changes as shown in FIG. 7 by changing composition of a polyurethane-based polymeric material, molecule structure, molecular weight or the like. To be more specific, for the sheet body 31, a glass transition point temperature Tg is set within a heating temperature range Ta-Tb, for example, with illumination light of the endoscope 100 which will be described later (see FIG. 9).

That is, the sheet body 31 has a high modulus of rigidity and is hard at a low temperature and solidified when deformed into a quasi-cylindrical shape as shown in FIG. 6. The sheet body 31 has a characteristic that its modulus of rigidity decreases and becomes softer as the temperature rises.

The camera 30 of the present embodiment configured as shown above and in a quasi-cylindrical shape as shown in FIG. 8 is introduced into the body of the patient, the abdominal cavity 101 here, using a treatment instrument 110 such as a grasping forceps via a trocar 105. That is, the camera 30 can be solidified by the sheet body 31 being deformed into a quasi-cylindrical shape so as to be able to pass through the trocar 105.

After introducing the camera 30 into the abdominal cavity 101, the user irradiates illumination light of the endoscope 100 introduced into the abdominal cavity 101 via another trocar 105 onto the entire sheet body 31 and warms up the sheet body 31 using this illumination light to a glass transition point temperature Tg or above. The sheet body 31 warmed up to the glass transition point temperature Tg or above then becomes softer, and therefore the user spreads the sheet body 31 so as to unfold using, for example, two treatment instruments 110 as shown in FIG. 9.

The user then causes the surface of the sheet body 31 to which an adhesive is applied to be pasted to the abdominal wall 102 using, for example, the two treatment instruments 110 as shown in FIG. 10 and leaves the camera 30 indwelling and fixed in the abdominal cavity 101.

As described above, with the camera 30 of the present embodiment as in the case of the first embodiment, the four illumination sections 33 provided around the camera unit 32 spread over a wide range as the sheet body 31 unfolds, and it is thereby possible to irradiate the image taking region of the image pickup unit in the camera unit 32 with illumination light of sufficient brightness and luminous intensity distribution.

That is, the camera 30 can be configured such that when introduced into the abdominal cavity 101, the sheet body 31 is rounded into a quasi-cylindrical shape and deformed into a shape so as to be able to pass through the trocar 105, warmed up with illumination light of the endoscope 100 when used, and the sheet body 31 is thereby made changeable so as to be unfolded and spread to increase the area irradiated with illumination light from the illumination sections 33. This allows the camera 30 to improve the brightness of illumination light and luminous intensity distribution. Thus, the camera 30 can have a configuration capable of obtaining sufficient illumination light to illuminate the object to be examined.

As the method of warming up the sheet body 31, heat generated when the illumination sections 33 of the camera 30 light up may be used instead of using heat of illumination light of the endoscope 100.

### First Modification Example

Next, a first modification example of the camera 30 of the present embodiment will be described based on FIG. 11 below.

The camera 30 of this modification example shown in FIG. 11 has a film-shaped configuration in which four illumination sections 33 use plane light sources of organic EL and solar panels 34, which are solar battery modules serving as solar power generation sections, are provided in the four corners of a sheet body 31. These four solar panels 34 generate power to drive the camera unit 32 and the respective illumination sections 33. The solar panels 34 are auxiliary power for a battery built in a camera unit 32.

The solar panels 34 directly receive illumination light of the endoscope 100 used together with the camera 30 (see FIG. 9) or indirectly receive reflected light or the like and convert light energy to electric power. Provision of such solar panels 34 in the camera 30 allows the camera 30 to be driven for a longer time than a power supply using only the battery.

The configuration of the solar panels 34 serving as the solar power generation sections is not limited to the present embodiment, but is also applicable to configurations of the above described first embodiment and the following embodiments.

### Second Modification Example

Next, a second modification example of the camera 30 of the present embodiment will be described based on FIG. 12 below.

The camera 30 of this modification example shown in FIG. 12 has a configuration in which two illumination sections 33 use plane light sources of organic EL here and a solar panel 34 is provided in part of the sheet body 31. Furthermore, an antenna 35 is provided along the perimeter of the sheet body 31 in the camera 30 of this modification example.

Thus, provision of the antenna 35 over a wide range of the sheet body 31 allows the camera 30 to improve directivity of radio wave that wirelessly transmits an image signal photoelectrically converted by the image pickup unit in a camera unit 32 to an external device and transmit the image signal efficiently.

### Third Embodiment

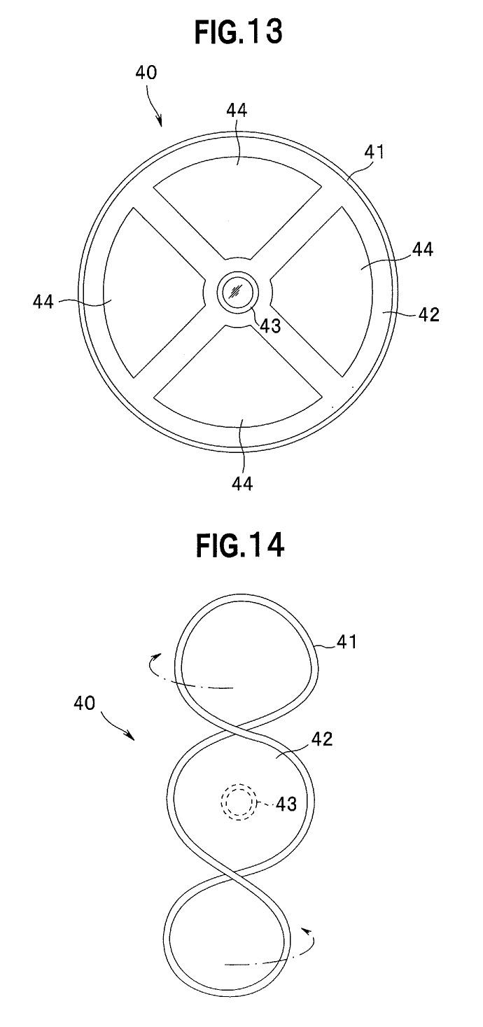

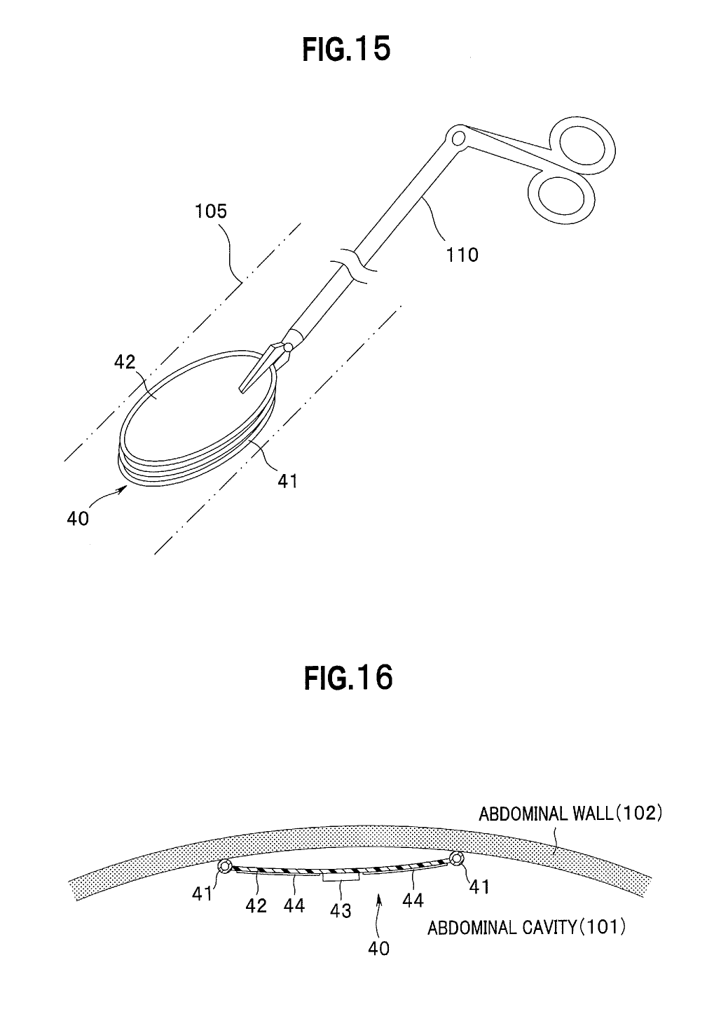

Next, a camera set up in the abdominal cavity according to a third embodiment, which is a medical instrument of the present invention, will be described below using FIG. 13 to FIG. 16. FIG. 13 to FIG. 16 are related to the third embodiment of the present invention. FIG. 13 is a plan view illustrating a configuration of a camera set up in the abdominal cavity, FIG. 14 is a diagram illustrating how the camera set up in the abdominal cavity is folded, FIG. 15 is a diagram illustrating how the camera set up in the abdominal cavity grasped by the treatment instrument is inserted into the trocar and FIG. 16 is a cross-sectional view illustrating the camera set up in the abdominal cavity, which is left indwelling and fixed to the abdominal wall in the abdominal cavity.

As shown in FIG. 13, the camera set up in the abdominal cavity (hereinafter simply referred to as “camera”) 40 of the present embodiment is configured by including a ring-shaped elastic wire 41, a disk-like thin-film sheet body 42 provided in a tensioned state on this elastic wire 41, a camera unit 43 disposed in substantially the center of one surface of the sheet body 42, which is image pickup means, and four illumination sections 44, which are illumination means, provided on the one surface of the sheet body 42 on which the camera unit 43 is disposed, so as to surround the camera unit 43.

A water-activated adhesive which makes up means for fixing to the body wall is applied to the surface of the elastic wire 41. This water-activated adhesive is an adhesive whose adhesive force is generated when a contact is made with the wet abdominal wall 102 as in the case of the second embodiment, which has biocompatibility such as fibrin-based adhesive/sticker, albumin-based adhesive/sticker or cyanoacrylate-based adhesive/sticker.

As in the case of the second embodiment, the camera unit 43 is provided with a solid image pickup device such as CCD or CMOS, and this solid image pickup device is provided with an objective lens group that condenses image taking light and incorporates an image pickup unit including a battery. Furthermore, as in the case of the second embodiment, the camera 40 is configured such that a video signal photoelectrically converted by the image pickup unit of the camera unit 43 is wirelessly transmitted to a receiver in an external device by a transmitter provided in the camera unit 43.

The four illumination sections 44 are configured to irradiate illumination light onto an object from film-shaped plane light sources of organic EL. Furthermore, these illumination sections 44 receive a power supply from a battery in the camera unit 43 as in the case of the second embodiment.

As shown in FIG. 14, the camera 40 of the present embodiment configured as shown above is, for example, twisted and deformed at two locations so that the elastic wire 41 forms three rings. The camera 40 is then deformed so that the three rings formed of the elastic wire 41 are folded so as to be superimposed on each other. As shown in FIG. 15, the camera 40 deformed in this way is introduced into the abdominal cavity 101 via the trocar 105 by grasping part of the superimposed elastic wire 41 using the treatment instrument 110 such as a grasping forceps.

The camera 40 introduced into the abdominal cavity 101 is restored to the ring shape as shown in FIG. 15 by a self-elastic force of the elastic wire 41, pasted, left indwelling and fixed to the abdominal wall 102. In this case, the camera 40 is pasted to the abdominal wall 102 by an adhesive force of the water-activated adhesive applied to the surface of the elastic wire 41 as shown in FIG. 16.

As described above, in the camera 40 of the present embodiment as in the cases of the above described embodiments, the four illumination sections 44 provided around the camera unit 43 spread over a wide range as the sheet body 42 unfolds, and it is thereby possible to irradiate the image taking region of the image pickup unit in the camera unit 43 with illumination light of sufficient brightness and luminous intensity distribution.

Furthermore, since the ring-shaped elastic wire 41 is provided around the sheet body 42, it is possible to easily fold and deform the camera 40 when the camera 40 is introduced into the abdominal cavity 101 and allow the camera 40 to easily pass through the trocar 105. Furthermore, when used, the camera 40 can be configured such that the sheet body 42 easily unfolds and spreads back into a disk shape by an elastic force of the elastic wire 41 (see FIG. 13).

### Fourth Embodiment

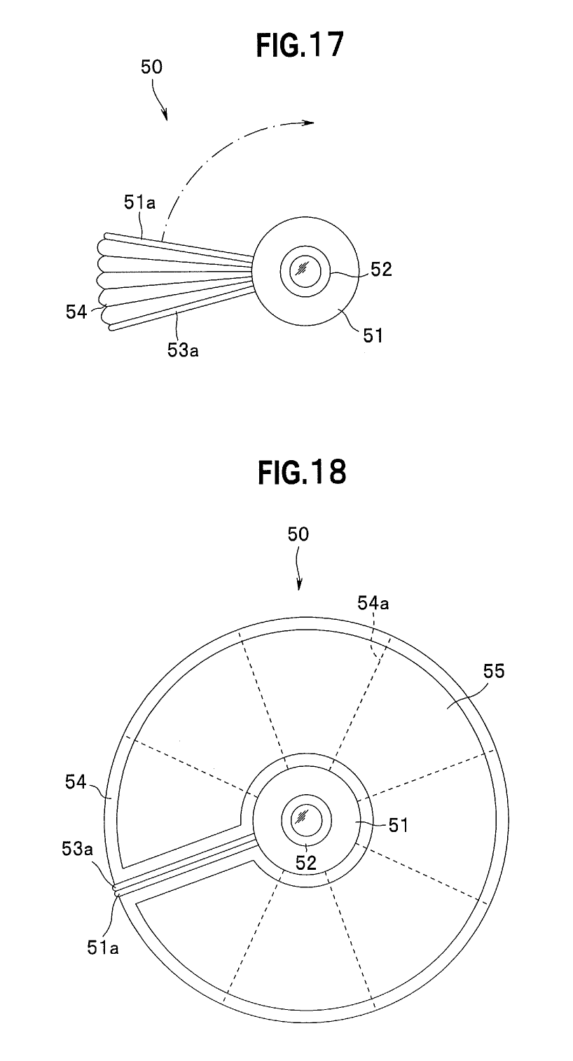

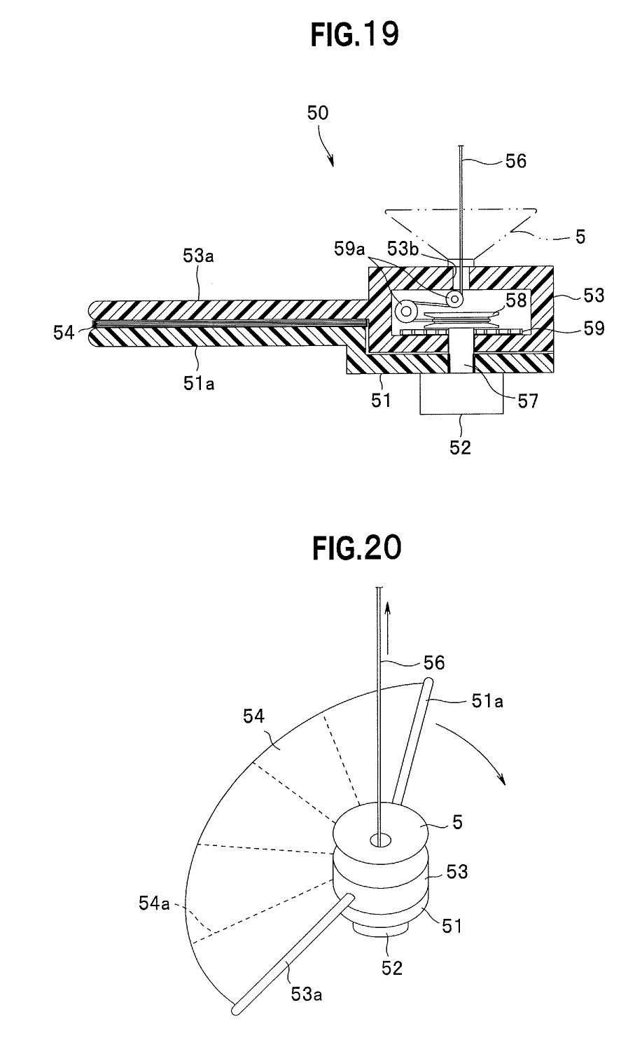

Next, a fourth embodiment of a camera set up in the abdominal cavity, which is a medical instrument of the present invention will be described using FIG. 17 to FIG. 20 below. FIG. 17 to FIG. 20 are related to the fourth embodiment of the present invention. FIG. 17 is a plan view illustrating a configuration of a camera set up in the abdominal cavity in which a sheet body provided with an illumination section is folded, FIG. 18 is a plan view illustrating the configuration of the camera set up in the abdominal cavity in which the sheet body provided with the illumination section is unfolded, FIG. 19 is a cross-sectional view illustrating the configuration of the camera set up in the abdominal cavity and FIG. 20 is a perspective view of the camera set up in the abdominal cavity to illustrate how the sheet body provided with the illumination section unfolds.

As shown in FIG. 17 to FIG. 19, the camera set up in the abdominal cavity (hereinafter simply referred to as “camera”) 50 of the present embodiment is configured by including a rotation section 51, a camera unit 52 disposed on one surface of this rotation section 51, which is image pickup means, an abdominal wall fixing section 53, on a top surface of which a suction cup 5, which is means for fixing to the body wall, is provided, a rotation section 51, a thin-film sheet body 54 disposed on the abdominal wall fixing section 53, an illumination section 55 disposed on one surface of the sheet body 54, which is illumination means, and an operation wire 56, which is operation means for causing, by pulling, the rotation section 51 to rotate with respect to the abdominal wall fixing section 53.

In the rotation section 51, a bar-shaped opening/closing section 51a extends from one side and one side of the sheet body 54 is pasted to the opening/closing section 51a.

As in the case of the second embodiment, the camera unit 52 of the present embodiment is also provided with a solid image pickup device such as CCD or CMOS and an objective lens group that condenses image taking light to this solid image pickup device and incorporates an image pickup unit including a battery. The embodiment has a configuration in which a video signal photoelectrically converted by the image pickup unit of the camera unit 52 is also wirelessly transmitted to a receiver of an external device by a transmitter provided in the camera unit 52.

In the abdominal wall fixing section 53, a bar-shaped opening/closing section 53a also extends from one side and the other side of the sheet body 54 is pasted to this opening/closing section 53a.

The sheet body 54 is made changeable from the folded state shown in FIG. 17 between the opening/closing section 51a of the rotation section 51 and the opening/closing section 53a of the abdominal wall fixing section 53 to a state in which the sheet body 54 unfolds into a disk shape and spreads as shown in FIG. 18 when the rotation section 51 rotates with respect to the abdominal wall fixing section 53, and the opening/closing sections 51a and 53a thereby open. That is, the sheet body 54 unfolds by rotating around the camera unit 52, that is, around the image taking optical axis of this camera unit 52. The unfolded and spread sheet body 54 has a quasi-disk-like shape. Furthermore, the sheet body 54 is provided with a plurality of (here seven) radially and uniformly spaced support bodies 54a that form a skeletal structure.

The illumination sections 55 of the present embodiment also have a configuration of irradiating illumination light onto the object to be examined using film-shaped plane light sources of organic EL. As in the case of the above described embodiments, these illumination sections 55 also receive a power supply from a battery in the camera unit 43.

In the abdominal wall fixing section 53, as shown in FIG. 19, a shaft body 57 that fixes the rotation section 51 and the camera unit 52 as one piece is pivotably disposed. A pulley 58 is provided at one end of the shaft body 57 in the abdominal wall fixing section 53 and urged by a spiral spring 59 in one rotation direction. The spiral spring 59 urges the shaft body 57 to rotate in a direction in which the sheet body 54 is folded between the opening/closing section 51a of the rotation section 51 and the opening/closing section 53a of the abdominal wall fixing section 53 shown in FIG. 17.

An end of the operation wire 56 is fixed to the pulley 58 of the shaft body 57 and the operation wire 56 is wound around the pulley 58. This operation wire 56 is wounded around the pulley 58 with the extending direction thereof changed by two rotating bodies 59a provided in the abdominal wall fixing section 53. Furthermore, the operation wire 56 is inserted into the suction cup 5 via a hole 53b formed in the center of the top surface of the abdominal wall fixing section 53 and extends outward.

In the camera 50 configured as described above, when the operation wire 56 wound around the pulley 58 is pulled in the abdominal wall fixing section 53, the rotation section 51 fixed to the shaft body 57 rotates with respect to the abdominal wall fixing section 53 against an urging force of the spiral spring 59. As shown in FIG. 20, the rotation direction of this rotation section 51 is a direction in which the opening/closing section 51a is made changeable from a state in which the opening/closing section 51a is separated apart from the opening/closing section 53a of the abdominal wall fixing section 53 and the sheet body 54 is folded (see FIG. 17) to a state in which the sheet body 54 is unfolded and spread in a quasi-disk shape (see FIG. 18).

As described above, the camera 50 of the present embodiment is introduced into the abdominal cavity 101, and can be made changeable, when used, to a state in which the folded sheet body 54 is unfolded and spread by pulling the operation wire 56. Thus, in the camera 50, the illumination section 55 provided in the sheet body 54 spreads over a wide range as in the case of the above described embodiments, and it is thereby possible to irradiate the image taking region of the image pickup unit in the camera unit 43 with illumination light of sufficient brightness and luminous intensity distribution.

### Fifth Embodiment

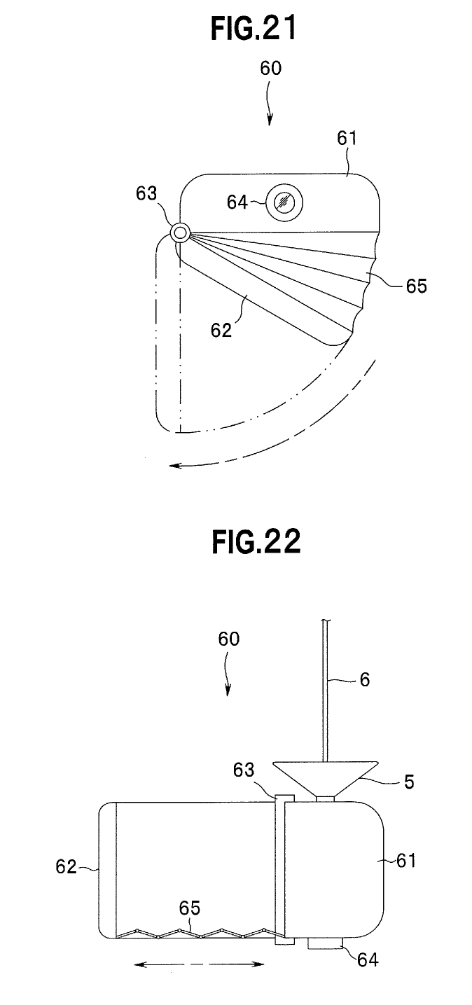

Next, a fifth embodiment of a camera set up in the abdominal cavity, which is a medical instrument according to the present invention will be described below using FIG. 21 and FIG. 22. FIG. 21 and FIG. 22 are related to the fifth embodiment of the present invention. FIG. 21 is a plan view illustrating a configuration of the camera set up in the abdominal cavity and FIG. 22 is a side view illustrating the configuration of the camera set up in the abdominal cavity in FIG. 21.

As shown in FIG. 17 and FIG. 18, the camera set up in the abdominal cavity (hereinafter simply referred to as “camera”) 60 of the present embodiment is configured by including a body section 61, a support plate 62 which is provided so as to be able to freely open/close with respect to this body section 61, a camera unit 64 provided in the body section 61, which is image pickup means, and a sheet body 65 provided between the body section 61 and the support plate 62.

The body section 61 is provided with a suction cup 5 making up means for fixing to the body wall disposed on a surface opposite to the surface on which the camera unit 64 is disposed as in the case of the first embodiment and a cable 6 extends from this suction cup 5. Furthermore, a hinge section 63 is provided in the joint between the body section 61 and the support plate 62 so that the support plate 62 is freely opened/closed with respect to the body section 61.

The sheet body 65 is disposed on the underside of the body section 61 on which the camera unit 64 is provided and includes an illumination section (not shown), which is illumination means. This sheet body 65 is unfolded into a fan shape and provided with creases so as to be foldable like bellows.

That is, the sheet body 65 is connected to the support plate 62 and the body section 61 at both ends and is made changeable between states in which the sheet body 65 is unfolded/spread and folded like a fan by opening/closing the support plate 62. The support plate 62 is opened/closed with respect to the body section 61 through an opening/closing operation using the treatment instrument 110 such as the aforementioned grasping forceps.

As described above, also with the camera 60 of the present embodiment, the support plate 62 is opened with respect to the body section 61 and the sheet body 65 is thereby unfolded to spread and the illumination section provided on the sheet body 65 spreads over a wide range, and it is thereby possible to irradiate the image taking region of the image pickup unit in the camera unit 64 with illumination light of sufficient brightness and luminous intensity distribution.

### Sixth Embodiment

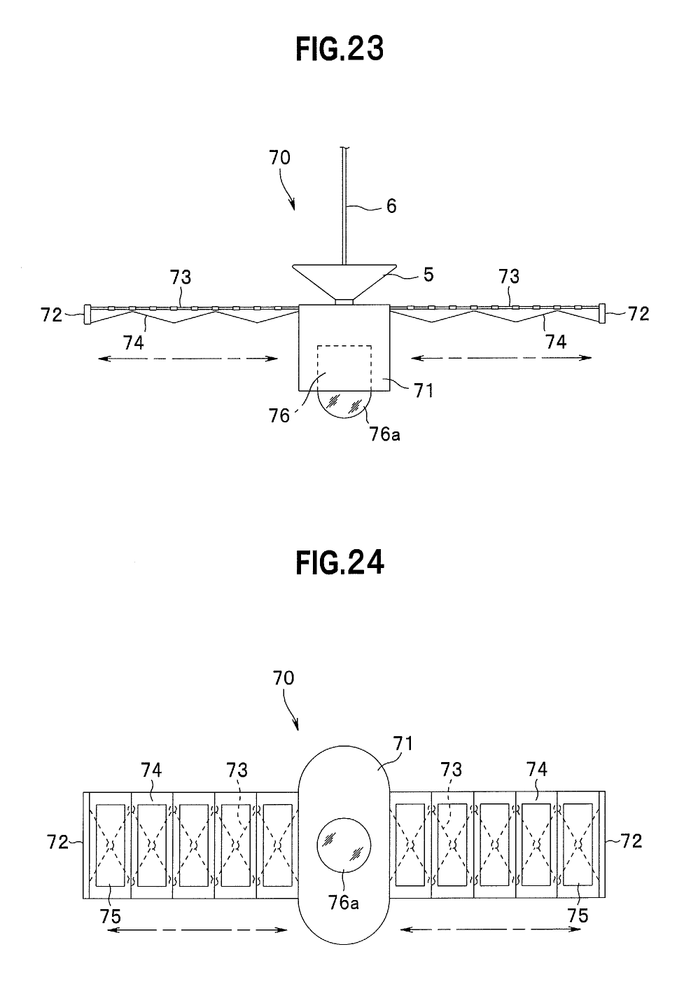

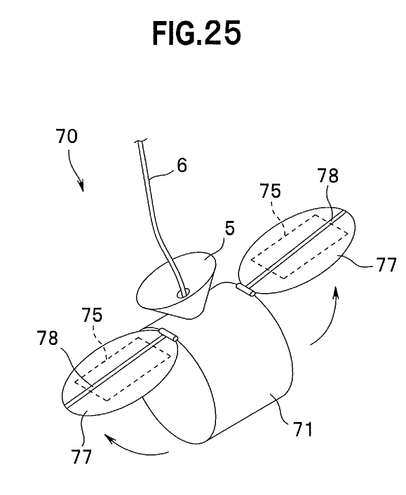

Next, a sixth embodiment of a camera set up in the abdominal cavity, which is a medical instrument according to the present invention will be described below using FIG. 23 to FIG. 25. FIG. 23 to FIG. 25 are related to the sixth embodiment of the present invention. FIG. 23 is a side view illustrating a configuration of the camera set up in the abdominal cavity, FIG. 24 is a plan view illustrating the configuration of the camera set up in the abdominal cavity in FIG. 23 and FIG. 25 is a perspective view illustrating a configuration of a camera set up in the abdominal cavity according to a modification example.

As shown in FIG. 23 and FIG. 24, the camera set up in the abdominal cavity (hereinafter simply referred to as “camera”) 70 of the present embodiment is configured by including a body section 71, telescopic sections 73 provided at both ends of the body section 71 forming two skeletal structures each provided with a support body 72 at one end and two rectangular sheet bodies 74, ends of which are connected to the body section 71 and the support body 72. A suction cup 5 making up means for fixing to the body wall is also provided on a top surface of the body section 71 of the present embodiment as in the case of the first embodiment and a cable 6 extends from this suction cup 5.

Furthermore, the body section 71 incorporates a camera unit 76, which is image pickup means, provided with a dome-shaped transparent cover 76a which is disposed so as to be exposed. This camera unit 76 is provided with a solid image pickup device such as CCD or CMOS and an objective lens group that condenses image taking light to this solid image pickup device as in the case of the first embodiment.

The telescopic section 73 has a plurality of bars provided in a grid-like shape and these bars are connected to each other so that pivoted sections where the bars cross each other are made rotatable. Thus, the telescopic section 73 is configured so as to extend or contract in both sideward directions of the body section 71 by the respective bars rotating around the pivoted sections.

The two sheet bodies 74 are provided with a plurality of creases in the short-side direction to form a strip-shaped configuration and a plurality of illumination sections 75, which are illumination means using organic EL as plane light sources, are disposed on the planes between the creases. That is, the sheet bodies 74 can be folded along the creases.

The sheet body 74 is connected to the body section 71 at one end in the longitudinal direction and connected to the support body 72 provided at the other end of the telescopic section 73, and is thereby made changeable between an open state in which the sheet body 74 is unfolded to spread and a closed state in which the sheet body 74 is folded along creases according to expansion/contraction of the telescopic section 73. That is, the sheet bodies 74 are placed in an open state in which the sheet bodies 74 unfold and spread in two opposing directions (separating from each other) orthogonally to the image taking optical axis of the camera unit 76 in a direction away from the camera unit 76. Furthermore, the sheet bodies 74 are placed in a closed state in which the sheet bodies 74 are folded along creases in two opposing directions (separating from each other) orthogonally to the image taking optical axis of the camera unit 76 in a direction approximating to the camera unit 76.

As described above, in the camera 70 of the present embodiment, the sheet body 74 unfolds and spreads with the expansion of the telescopic section 73 and the illumination sections 75 provided in the sheet body 74 spread over a wide range, making it possible to irradiate the image taking region of the image pickup unit in the camera unit 76 with illumination light of sufficient brightness and luminous intensity distribution.

The expansion/contraction operation of the telescopic section 73 can be performed by operating the support body 72 using the treatment instrument 110 such as the aforementioned grasping forceps. Furthermore, each bar of the telescopic section 73 may be formed, for example, of a Ni-Ti-based shape-memory alloy and each bar may store the shape thereof so that the telescopic section 73 expands and the sheet body 74 unfolds and spreads when the camera 70 is introduced into the abdominal cavity 101 and the telescopic section 73 is warmed up to a body temperature.

### Modification Example

Next, a modification example of the camera 70 of the present embodiment will be described below based on FIG. 25.

As shown in FIG. 25, the camera 70 of this modification example is provided with two disk-like panel-shaped sheet bodies 77 at both ends of a body section 71. An illumination section 75 is provided on one side of each of these sheet bodies 77.

Each sheet body 77 is connected to the body section 71 via a connection body 77 formed of a Ni-Ti-based shape-memory alloy. This connection body 78 extends on the one side of the sheet body 77 and makes up a support section that supports the sheet body 77.

The camera 70 configured in this way is introduced into the abdominal cavity 101, and when the connection body 78 that supports the sheet body 77 is warmed up by a body temperature, each sheet body 77 springs up from the side of the body section 71. That is, when warmed up by the body temperature, the connection body 78 has shape-memory stored therein so as to cause each supported sheet body 77 to spring up from the side of the body section 71.

As described above, the camera 70 of this modification example is configured such that when introduced into the abdominal cavity 101 and warmed up by the body temperature, the sheet bodies 77 provided with the illumination sections 75 naturally spring up from the body section 71 and the illumination sections 75 spread over a wide range so as to irradiate the image taking region of the image pickup unit in the camera unit 76 with illumination light of sufficient brightness and luminous intensity distribution.

### Seventh Embodiment

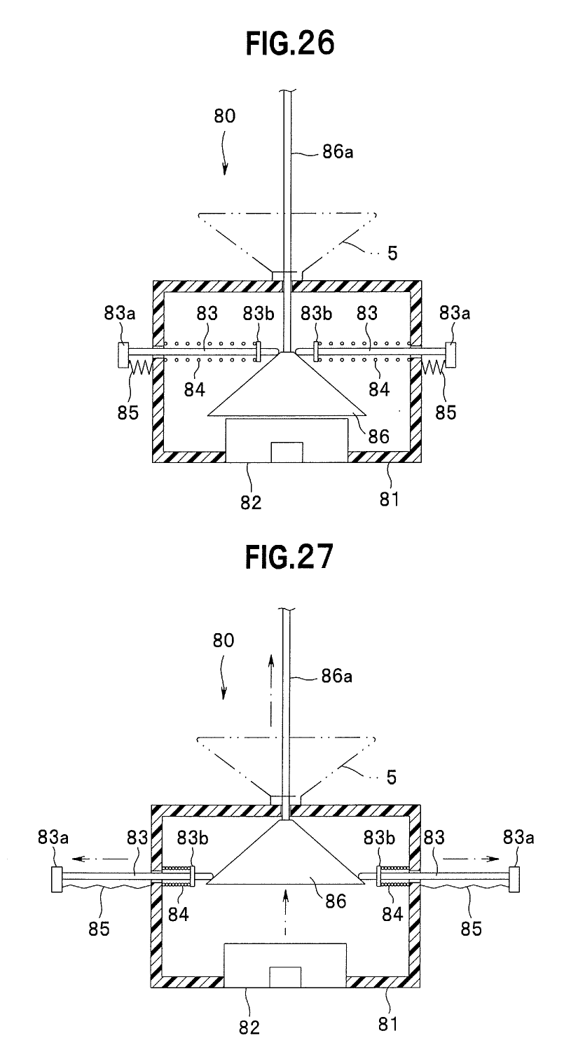

Next, a seventh embodiment of a camera set up in the abdominal cavity, which is a medical instrument according to the present invention will be described below using FIG. 26 and FIG. 27. FIG. 26 and FIG. 27 are related to the seventh embodiment of the present invention. FIG. 26 is a cross-sectional view illustrating a configuration of the camera set up in the abdominal cavity and FIG. 27 is a plan view illustrating the camera set up in the abdominal cavity in FIG. 26, in which the sheet body is unfolded.

As shown in FIG. 26, the camera set up in the abdominal cavity (hereinafter simply referred to as “camera”) 80 of the present embodiment is configured by including a body section 81, a camera unit 82 which is image pickup means, two bar-shaped slide bodies 83 disposed so as to penetrate the body section 81 on both sides thereof, two rectangular sheet bodies 85, on one surface of which an illumination section which is illumination means (not shown) is disposed and a triangular pyramid-shaped mobile body 86 disposed in the body section 81 to which an operation wire 86a, which is operation means, is connected.

Each slide body 83 is provided with a support body 83a with an end of the sheet body 85 connected to an end that protrudes from the side of the body section 81 and an outward flange 83b is formed at the other end in the body section 81. These slide bodies 83 are inserted through springs 84 in the body section 81.

The spring 84 is disposed so that one end thereof contacts the inner wall of the body section 81 and the other end contacts the outward flange 83b of the slide body 83.

One end of each sheet body 85 is connected to the support body 83a of the slide body 83 and the other end thereof is connected to the wall surface of the body section 81. Each sheet body 85 is provided with an illumination section using organic EL as a plane light source on the underside thereof.

The mobile body 86 is connected to the operation wire 86a at the top end thereof and is disposed in the body section 81 so that this top end becomes the vertex. This operation wire 86a passes through the top surface of the body section 81 and extends outward via the suction cup 5. Furthermore, the end of the slide body 83 urged by the spring 84 is always in contact with the surface of the mobile body 86.

In the camera 80 configured as described above, when the mobile body 86 is lifted by pulling the operation wire 86a as shown in FIG. 27, each slide body 83, one end of which is in contact with the surface of this mobile body 86 slides from the side of the body section 81 in the protruding direction against the urging force of the spring 84. The two sheet bodies 85 connected to the support bodies 83a of the respective slide bodies 83 follow the slide bodies 83 and spread so as to unfold. That is, the respective sheet bodies 85 are set in an open state by being unfolded and spread in two opposing directions (separating from each other) orthogonally to the image taking optical axis of the camera unit 82 in a direction away from the camera unit 82. Furthermore, the respective sheet bodies 85 are set in a closed state by being folded along creases in two opposing direction (separating from each other) orthogonally to the image taking optical axis of the camera unit 82.

Thus, in the camera 70 of the present embodiment, the two sheet bodies 85 are unfolded and spread as the respective slide bodies 83 move and the illumination sections provided on the sheet bodies 85 spread over a wide range, and it is thereby possible to irradiate the image taking region of the image pickup unit in the camera unit 82 with illumination light of sufficient brightness and luminous intensity distribution.

According to the medical instrument, which is the present invention according to the above described embodiments, even when a small configuration is adopted, it is possible to irradiate an object to be examined, images of which are taken by an image pickup apparatus, with illumination light of sufficient brightness and luminous intensity distribution.

As an application of the camera unit, which is the image pickup apparatus used in the present invention, the techniques in the aforementioned embodiments are also applicable to cases where in an operation of extirpating a tumor of thoracic cavity or abdominal cavity, 5-ALA (aminolevulinic acid) is administered by mouth, intravenous injection or the like before or after operation, and lymph node or pleural metastasis, peritoneal metastasis or the like to which a malignant tumor is suspected to have metastasized is irradiated with excitation light and images of fluorescence generated from the 5-ALA (aminolevulinic acid) are thereby picked up.

Furthermore, the techniques in the aforementioned embodiments are also applicable to cases where a diagnosis is made by observing fluorescence using an image pickup apparatus (e.g., endoscope, surgical field camera) during an operation, and such a diagnosis is made by removing fat or membrane that constitutes an impediment to the observation.

What is claimed is:

1. A medical instrument used by being introduced into a body and fixed thereto, comprising:
a fixing section fixed to a body wall in the body;
an image pickup section that picks up an image of an object to be examined in the body;
an illumination section that illuminates the object to be examined in the body; and
a sheet body in which the illumination section is disposed and which is made unfoldable so as to form a plane that spreads over a wide angle from a direction orthogonal to a central axis of the illumination section in an illumination direction so that an irradiation region of illumination light is expanded in an image pickup region of the image pickup section and a wide range is irradiated with the illumination light.

2. The medical instrument according to claim 1, wherein the sheet body is unfolded so as to spread around the image pickup section.

3. The medical instrument according to claim 2, wherein the sheet body is disk-shaped and unfolds by rotating around an image taking optical axis of the image pickup section.

4. The medical instrument according to claim 1, wherein the sheet body unfolds in a direction away from the image pickup section.

5. The medical instrument according to claim 4, wherein the number of the sheet bodies is two and each sheet body has a rectangular shape and unfolds in two opposing directions orthogonal to an image taking optical axis of the image pickup section.

6. The medical instrument according to claim 1, further comprising an operation section that unfolds and spreads the sheet body.

7. The medical instrument according to claim 1, wherein the sheet body is formed of a shape-memory polymer whose modulus of rigidity is variable with temperature.

8. The medical instrument according to claim 1, further comprising a ring-shaped elastic wire that unfolds and spreads the sheet body in a tensioned state.

9. The medical instrument according to claim 1, wherein the sheet body includes a solar power generation section that generates drive power of the image pickup section and the illumination section.

10. A medical instrument used by being introduced into a body and fixed thereto, comprising:
fixing means fixed to a body wall in the body;
image pickup means for picking up an image of an object to be examined in the body;
illumination means for illuminating the object to be examined in the body; and
a sheet body in which the illumination means is disposed and which is made unfoldable so as to form a plane that spreads over a wide angle from a direction orthogonal to a central axis of the illumination section in an illumination direction so that an irradiation region of illumination light is expanded in an image pickup region of the image pickup means and a wide range is irradiated with the illumination light.
